(19) United States
(12) Patent Application Publication
(10) Pub. No.: US 2003/0188010 A1
(43) Pub. Date: Oct. 2, 2003

(54) Peer to peer mixed media messaging

(76) Inventors: Imran Raza, Lake Worth, FL (US); Venkatram Reddy Aurva, Plantation, FL (US); Syed Ahson, Plantation, FL (US); Deepak P. Ahya, Plantation, FL (US); Sanigepalli Praveenkumar, Plantation, FL (US); Faisal Saeed, Sunrise, FL (US)

Correspondence Address: Scott M. Garrett, Motorola, Inc., Law Department, 8000 West Sunrise Boulevard, Fort Lauderdale, FL, 33322, US

(21) Appl. No.: 10/108,131

(22) Filed: Mar. 27, 2002

(51) Int. Cl. G06F 15/173

(52) U.S. Cl. 709/238

(57) ABSTRACT

A peer to peer messaging protocol allows for messaging using a variety of media and for changing the media during a messaging session. The protocol requires far less code space to implement over existing messaging protocols, such as session initiation protocol, and real time transport protocol. The protocol employs a capability exchange (602) for establishing the media capabilities of the respective peer devices as both a request and the final negotiation. The capability exchange messages use a common header (103) that is also used in subsequent data transmissions carrying the actual message content.

### TECHNICAL FIELD

This invention relates in general to messaging between peer entities over a packet network, and more particularly to a method for performing mixed media messaging where the media capability of the respective peer entities is initially unknown to each other, and where the message session set up must be performed rapidly.

### BACKGROUND OF THE INVENTION

Messaging between peer devices over networks is common in both private networks and over wide area public networks such as the Internet. The most common example of such messaging application is known as “instant” messaging where one person sends a text message from one computer to another person at another computer over a network. A messaging client application is used by both persons to send and receive messages. The messaging session permits faster communication than electronic mail, or email, for example. This type of messaging is also sometimes referred to as “chat” because the speed at which the messages can go between the users allows for a virtual conversation to take place. The use of messaging client applications has increased dramatically with the Internet, and presently efforts are underway to expand messaging from text only to other media types, and to other networks.

The types of networks in particular that is desirable to conduct messaging over are wireless mobile communication networks. These networks traditionally support telephonic voice communication over radio interfaces that allow the communication device to roam through a region, and the call is handed off from one serving cell to the next as the mobile communication device moves form cell to cell, as is well known in the art. Traditional messaging is performed using computers that are physically wired to networks. Thus, the traditional messaging format is not mobile. Considering that people spend considerable amount of time away from computers, it is desirable to implement messaging on mobile devices. At the same time there is a desire to allow messaging of not simply text, but also sound and image and video, or mixed media. However, the existing means that facilitate messaging using mixed media, while suitable to computers, are not particularly suitable to mobile communication devices.

One reason why existing means are not well suited for performing messaging with mobile devices is that in packet networks the traditional protocols used are session initiation protocol (SIP) to set up a messaging session, and real time transport protocol (RTP) to commence transmitting the actual data. These are established protocols set forth by the Internet Engineering Task Force. However, the code used to implement these protocols requires what is considered a large memory space for a mobile communication device. Another disadvantage is latency in setting up a mixed media messaging session with these protocols. The latency typically experienced is too long to be considered acceptable in mobile communication devices. Therefore there is a need for a mixed media messaging method where the protocol is such that it requires less code space to implement, and it reduces the latency over existing messaging methods.

### BRIEF DESCRIPTION OF THE DRAWINGS

FIG. 1 shows a diagram of a data structure used in a messaging session request and a messaging session acknowledgement, in accordance with the invention;

FIG. 2 shows a data structure diagram for packets used in messaging between devices once the messaging parameters have been negotiated;

FIG. 3 shows a data structure diagram of a data acknowledgement, in accordance with the invention;

FIG. 4 shows a state diagram illustrating the state changes in a device utilizing the protocol invention;

FIG. 5 shows a signal diagram of a typical signal flow between peers using a messaging protocol in accordance with the invention; and

FIG. 6 shows a signal flow diagram illustrating contingency procedures in the event of a messaging failure.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward. A brief description of the prior art is also thought to be useful.

The invention solves the problems of reducing the code space to implement a messaging protocol, and it reduces the latency of setting up messaging sessions over mobile wireless bearer networks by defining a new protocol and a new method of setting up messaging sessions between peers where at least one peer is a mobile wireless communications device. In particular the invention provides for a common header to be used in both messaging session requests and acknowledgments, as well for transporting message content. The message header contains a protocol identifier, a call identifier, a message type, and a sub type field, as will be explained in further detail. When establishing a messaging session between peers, an mitiating device transmits a messaging session request to the target device, which, be means of the header, informs the target as to the requesting device's media capabilities. In responding, the target device transmits an acknowledgement that contains the parameters by which the messaging can commence, based on its media capabilities and the requesting device's capabilities. The invention further provides for contingency processes for handling errors and failures.

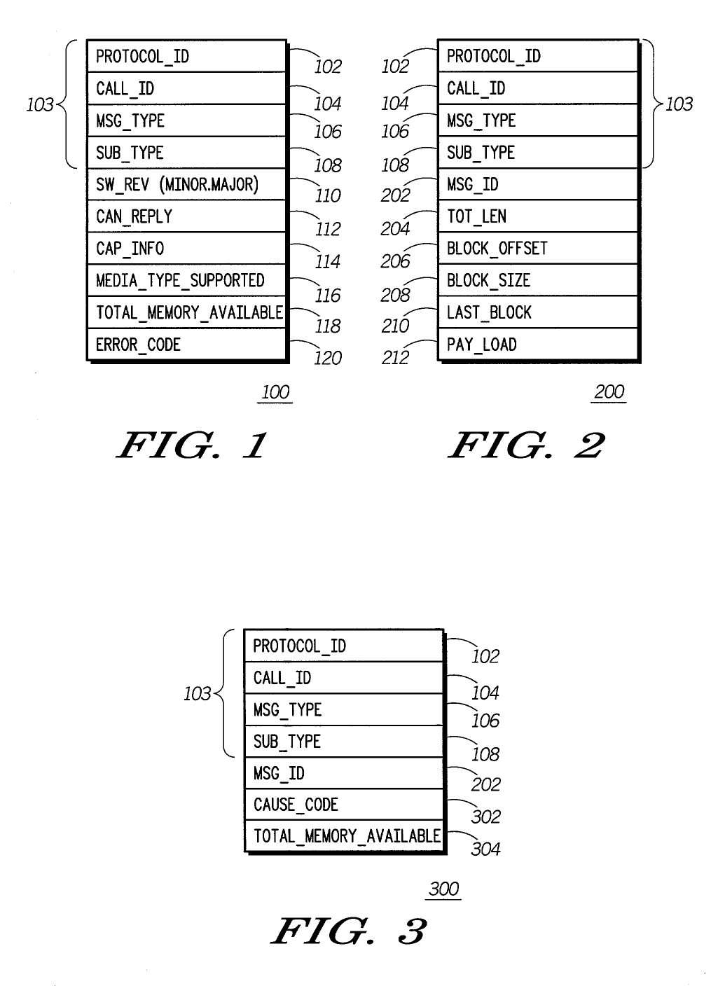

Referring now to FIG. 1, there is shown a diagram of a data structure 100 used in a messaging session request and a messaging session acknowledgement, in accordance with the invention. The protocol of the invention is carried out at the application layer, with routine support from lower layers. The layers referred to herein are the OSI layers well known in the art. The data structure, or packet structure, shown in FIG. 1 is used both by the initiating device in attempting to establish a messaging session with a target device, and by the target device in replying to the initiating device. The protocol identifier 102 is the first of 4 fields which constitute a header 103 that is used both in message session set-up as well as the actual messaging. The protocol identifier is used by lower layers to route the data to the messaging application. The call identifier 104 identifies the particular messaging session. It is generated by the initiating device, and in the preferred embodiment is a random number. The number is used by both peers to identify to which messaging session the information in the rest of the packet belongs. In the event the random number is the same as one already in use by the target device, the target device may optionally generate a new call identifier and use the new call identifier in its response. The message type field 106 identifies whether the packet is control information, such as a messaging session request, or actual messaging data. The sub type field 108 indicates the media type. Some examples of media are text, voice or audio, MPEG, JPEG, and other video or image media. These media types can be further defined. For example, voice media can be exchanged as encoded data, such as vector sum excited linear predictive (VSELP) coding, and more particularly a coding rate may be selected. These four fields constitute a common header used in all messaging, both control and data, between the peers.

The next 6 fields are found only in control messages such as messaging session requests and acknowledgements. The software version field 110 indicates the version of code being used to ensure compatibility. The can reply field 112 indicates whether the device sending the control message can reply using text or voice, or both, or video. The capability information field 114 is used to indicate what media hardware the sending device contains. For example, the device can indicate that it has a speaker, a text display, a video capable display, a microphone, and so on. Furthermore, the capability field is used to indicate more detailed hardware parameters such as what vocoder rate the device is capable of, and the interleave or interleaves supported by the device. The interleave is used in time divisioned air interfaces, and indicates how many time slots constitute a frame. Stated another way, it indicates how channels can be defined in a specific frequency band in a time division system. The media type supported field 116 indicates, apart from the hardware available, what type of media can be supported, such as by software applications available in the device. This is different than the can_reply field 112. The media type field 116 indicates what media the sending device can handle. The can_reply field indicates what type of media the device can send. The total memory field 118 indicates how much memory is available in the sending device. This information can be used by the messaging application software to tailor subsequent messages so the receiving device is not overburdened with information. Finally, the error code field 120 is used to indicate any errors when responding, such as, for example, if the call identifier negotiation fails.

Referring now to FIG. 2, there is shown a data structure diagram 200 for packets used in messaging between devices once the messaging parameters have been negotiated. That is, this structure is used for the actual information content, the message, being sent. Because the message being sent will typically be fragmented at the transmitting device, the receiving device needs enough information to reassemble the message. Each packet comprises the common header 103 including a protocol identifier 102, a call identifier 104, and message and sub type fields, 106 and 108, respectively. Furthermore the packet contains a message identifier 202 to indicate to which particular message the packet belongs. Over the course of a messaging session, each device may send numerous messages. For example, in a text messaging session, the respective users can engage in what is known as a “chat” session, exchanging text messages akin to a conversation. The packet contains a field indicating the total length 204 of the particular message to which the present packet belongs. The total length field is used in conjunction with the block offset 206, block size 208 and last block 210 fields to reassemble the packets in the proper order. The total length is typically expressed in bytes. Since a message is composed in its entirety before being sent, the sending device can easily determine the length of the message, as well as the other parameters needed for fragmentation and reassembly. The block offset 206 indicates the next packet starting address, meaning the address of the block in the actual message. The block size 208, as the name suggests, indicates the valid size of the block. The last block field 210 is used to indicate the number of the last block. Finally the payload 212 is part of the actual message being relayed. The information in the payload, when reassembled in accordance with the preceding five fields, constitutes the message. The message, as indicated above, may be one of several types of media.

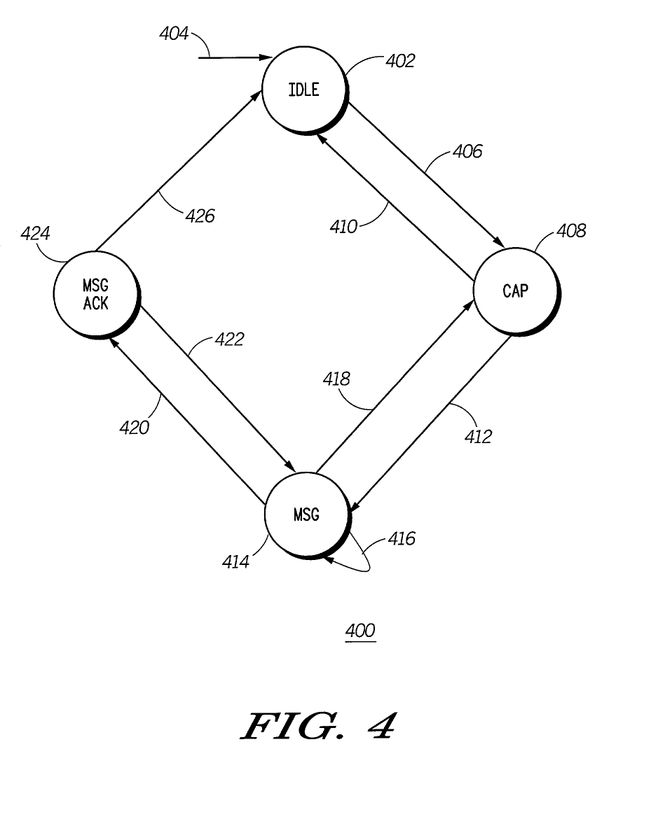

Referring now to FIG. 3, there is shown a data structure diagram 300 of a data acknowledgement, in accordance with the invention. This structure is used to acknowledge receipt of data in response to receiving data in accordance with the structure shown in FIG. 2. The common header 103 is used here as well, and so is the message identifier 202. The receiving device will provide a cause code 302 after a message has arrived. The cause code indicates if the message was received successfully, of if it failed, an indication of the nature of the failure. For example, a failure may occur due to the device being busy, one or more packets were not received correctly, the memory may be full, or there may be a vocoder mismatch. Finally, the total memory field 304 indicates the remaining memory in the receiving device after successfully receiving the message.

Referring now to FIG. 4, there is shown a state diagram 400 illustrating the state changes in a device utilizing the protocol invention. The method of performing messaging in accordance with the messaging protocol of the invention begins with the device in an idle state 402. The device receives a messaging request 404 from the messaging application, including the address of the target peer the user of the device wishes to send a message. The address may be an internet protocol address, or, optionally, an alias to be resolved by a server, as is known in the art. In response to the messaging request 404, the initiating device sends a messaging session request 406, using the structure shown in FIG. 1, and is then in a capability determination state 408. Essentially one of two events can occur at this point; the messaging session request may fail, or a time period for receiving a reply may expire 410, or a capability acknowledgement 412 may be received. The capability acknowledgement is a messaging session acknowledgement, and also uses the structure shown in FIG. 1. Upon receiving a messaging session acknowledgement, the initial parameters of the messaging session have been decided and the device is in the messaging state 414. The device then begins transmitting or receiving packets of information in accordance with the structure shown in FIG. 2. This process (416) occurs for all but the last message fragment. During this process, the device may need to renegotiate the parameters of the messaging session, and will send another messaging session request to check capabilities (418). Transmission of the last message fragment 420 takes the device to the message acknowledgement state 424. The device then waits to receive a data acknowledgement 422, or the messaging may fail or timeout 426.

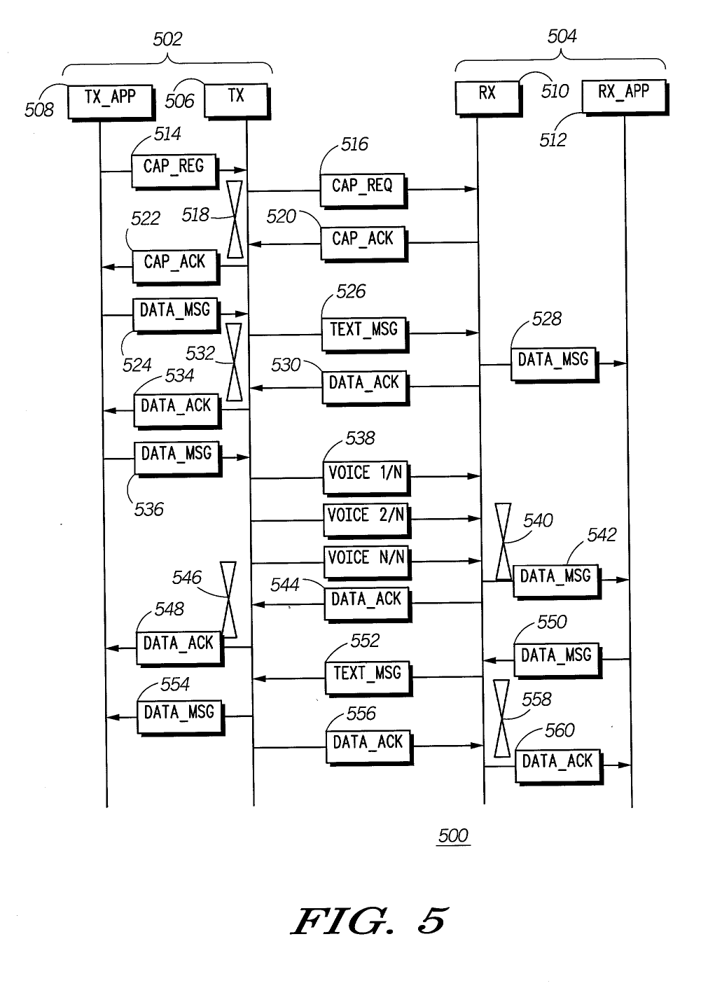

Referring now to FIG. 5, there is shown a signal diagram 500 of a typical signal flow between peers using a messaging protocol in accordance with the invention. The diagram shows the flow of messaging between an initiating peer 502 and a target peer 504. The initiating peer includes a transceiver 506 controlled by a suitable operating system for controlling the hardware and providing support for software applications, such as a messaging application 508 which operates in accordance with the invention. Similarly, the target peer has a transceiver 510 and messaging application 512. The messaging begins with a capabilities exchange and negotiation, followed by messaging. In initiating the messaging session, the messaging application generates a capabilities request, which is a messaging session request 514. This control message includes data as shown and described in accordance with FIG. 1. The messaging session request is sent over the network 516 to the target peer. After transmitting the message session request, the initiating device begins a timer 518. If the time period of the timer expires before receiving a response from the target device, a contingency process is undertaken. Upon receiving the messaging session request, the target peer responds with a messaging session acknowledgement 520 including the capabilities of the target peer. The messaging session acknowledgement is in the same data format as the messaging session request, but potentially with different parameters in the respective data fields which reflect the negotiated parameters by which the peers may commence messaging. When the acknowledgement is received at the initiating device, it is passed 522 to the messaging application. At this point the messaging session or messaging call is established and messaging may commence.

It should be noted that the exchange of information between these peers over the network is preferably accomplished with internet protocol mechanisms well known in the art, including over wireless mobile channels at each end of the network. However, the protocol is equally applicable with other network types. Furthermore, it will be appreciated by those skilled in the art that the peer devices may be any one of a variety of computing devices such as, for example, mobile communication devices, personal computers, handheld or palmtop computers, personal digital assistants, and so on.

The messaging application forms a message, such as a text message, by receiving information from the user of the initiating device via a messaging user interface. The information is buffered by the messaging application until the user wishes to transmit the message, at which time the message is formatted by the messaging application into a structure in accordance with the structure shown in FIG. 2, and routed 524 to the transceiver. The transceiver transmits 526 the text message to the target device over the network. Upon reception at the target device, the text message is routed 528 to the messaging application of the target device. The target device also transmits a data acknowledgement 530 back to the initiating device. A timer 532 begins after the text message is sent by the initiating device, and if the data acknowledgement isn't received in the appropriate time, a contingency process is undertaken. The data acknowledgement, upon reception at the initiating device, is routed 534 to the messaging application.

Because the protocol is designed to support a variety of media, the devices can change the media type during the messaging session, so long as the initial capabilities exchange indicates other media are supported. However, media messages other than text may need to be sent in fragments because of size of the message. For example, a voice message may be recorded at the initiating device, and then transmitted 538 to the target device. However, because of limitations in the network, the message may require fragmentation into n fragments. These fragments are transmitted sequentially to the target device using the same data structure used to transmit text and other media, and is designated as such in the sub type field 108 of the common header. At the receiving device, when the first fragment is received, it begins a timer 540 to time the period between receipt of message fragments. If the timer expires before receipt of the next fragment, or all of the fragments, the receiving device undertakes an appropriate contingency procedure. If all of the fragments arrive within the allowed time period, the fragments are concatenated in their proper order and the whole message is delivered 542 to the messaging application, where the voice message is played. To play the voice message, the messaging application may, for example, invoke an applet designed to play voice content. Also after receiving all the fragments successfully, the receiving device transmits a data acknowledgement 544. Upon transmitting the last fragment, the sending device preferably begins a timer 546. If the data acknowledgement is not received before the expiration of the timer 546, the sending device undertakes an appropriate contingency procedure, such as indicating to the user of the device, via the user interface, a failure message. Once the data acknowledgement is received before the expiration of the timer 546, it is routed 548 to the messaging application of the sending device, and the successful transmission of the message may be indicated to the user via the user interface.

In response to receiving the voice message, the user of the target device may, for example, wish to respond to the user of the initiating device. To illustrate the benefit of being able to perform mixed media messaging within a messaging session, assume the user of the target device is in a location where it would not be appropriate to speak, such as in a meeting. So, to respond, the user of the target device composes a text message reply. The text message is then routed 550 from the messaging application to the transceiver which transmits 552 the text message to the initiating device over the network. Upon receiving the text message, it is routed 554 to the messaging application. In response, and in accordance with the preferred embodiment, the initiating device transmits 556 a data acknowledgement to the target device. Also, in accordance with the preferred embodiment of the device, the target device runs a timer 558 after sending the text message in case the data acknowledgement isn't received in a reasonable period of time. When the data acknowledgement is received, it is routed 560 the messaging application of the target device so that an indication of success can be given to the user of the target device.

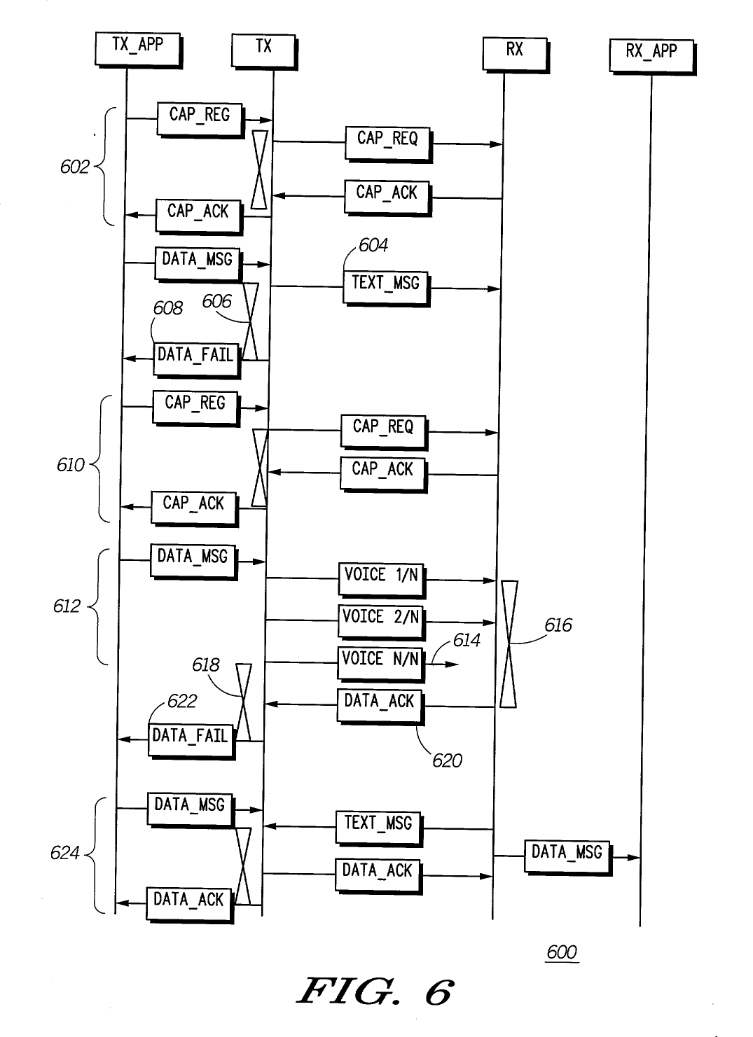

Referring now to FIG. 6, there is shown a signal flow diagram 600, illustrating some contingency procedures in the event of a messaging failure. The messaging session set-up occurs as shown and described according to FIG. 5 at 602: the peer devices exchange capability information, and messaging session parameters. The initiating device then prepares a text message and transmits 604 the text message to the target device. At the same time the initiating device begins a timer 606. Here, however, the timer expires before an acknowledgement is received. Therefore a data fail message 608 is returned to the messaging application of the initiating device.

Upon receiving the failure message, the user of the initiating device may decide to attempt to re-establish the messaging session by initiating another capability exchange 610. However, for the sake of example, the user of the initiating device now decides to send a voice message 612. The message is fragmented as in FIG. 5, but here the last fragment 614 is not received by the target device. The target device runs a timer 616, and at the end of the timer time period, the target device transmits a data acknowledgement 620. As with all other data acknowledgements, this data acknowledgement is in the form of the structure shown in FIG. 3. However, because the last fragment was never received, the cause code 302 indicates there was an error, and the nature of the error. The initiating device expects the data acknowledgement, and runs a timer 618. Upon receiving the data acknowledgement indicating the failure, a data failure message 622 is routed to the messaging application. Finally, a text message is transmitted successfully 624 in accordance with the established messaging parameters already negotiated.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method of providing mixed media messaging between peers over a packet network, comprising:
sending a messaging session request from a first peer to a second peer over the packet network, the messaging session request including a media capability description of the first peer;
receiving at the first peer a messaging session acknowledgement over the packet network from the second peer, the messaging session acknowledgement including a media capability description of the second peer; and
commencing a messaging session with the second peer from the first peer using a preferred media.

2. A method of providing mixed media messaging as defined by claim 1, wherein the sending, receiving and commencing the messaging session are performed where the first peer is a mobile communication device and the network includes a wireless mobile network.

3. A method of providing mixed media messaging as defined by claim 1, wherein the sending, receiving and commencing are performed by sending packets over the packet network, each packet having a header comprising a protocol identifier field.

4. A method of providing mixed media messaging as defined by claim 1, wherein the sending, receiving and commencing are performed by sending packets over the packet network, each packet having a header comprising a call identifier field.

5. A method of providing mixed media messaging as defined by claim 1, wherein the sending, receiving and commencing are performed by sending packets over the packet network, each packet having a header comprising a message type field.

6. A method of providing mixed media messaging as defined by claim 1, wherein the sending, receiving and commencing are performed by sending packets over the packet network, each packet having a header comprising a sub type field.

7. A method of providing mixed media messaging as defined by claim 1, wherein the sending, receiving and commencing are performed by sending packets over the packet network, each packet having a header comprising a protocol identifier field, a call identifier field, a message type field, and a sub type field.

8. A method of providing mixed media messaging as defined in claim 1, further comprising running a timer after sending the message session request, and undertaking a contingency procedure if the message session acknowledgement is not received before expiration of the timer.

9. A method for performing mixed media messaging between a first and a second mobile communication device over a packet network, comprising:
transmitting a messaging session request from the first mobile communication device to the second mobile communication device over the packet network, the messaging session request including a common header for each packet used to transmit the messaging session request, the common header including variable data fields for indicating a protocol identifier, a call identifier, a message type, and a sub type, the messaging session request including a body for indicating a media capability of the first mobile communication device;
receiving the messaging session request at the second mobile communication device;
transmitting a messaging session acknowledgment from the second mobile communication device to the first mobile communication device over the packet network, the messaging session acknowledgment including the common header for each packet used to transmit the messaging session acknowledgement, the message session acknowledgement including a body for indicating a media capability of the second mobile communication device;
receiving the messaging session acknowledgement at the first mobile communication device;
if the messaging session acknowledgement indicates the media capabilities of the first and second mobile communication devices are compatible, commencing a messaging session utilizing a preferred media type for transmitting messages between the first and second mobile communication devices, including using the common header for each packet used to transmit the messages.

10. A method for mixed media messaging as defined by claim 9, wherein the body of the messaging session request and messaging session acknowledgement include variable data fields for indicating a voice, text, and image capability.

11. A method for mixed media messaging as defined by claim 9, wherein the body of the messaging session request and messaging session acknowledgement include variable data fields for indicating a vocoder capability.

12. A method for mixed media messaging as defined by claim 9, wherein the body of the messaging session request and messaging session acknowledgement include variable data fields for indicating a user interface capability.

13. A method for mixed media messaging as defined by claim 9, wherein the body of the messaging session request and messaging session acknowledgement include variable data fields for indicating a reply capability.

14. A method for mixed media messaging as defined by claim 9, wherein the body of the messaging session request and messaging session acknowledgement include variable data fields for indicating a memory capability.

15. A method for mixed media messaging as defined by claim 9, wherein the body of the messaging session request and messaging session acknowledgement include variable data fields for indicating a voice, text, and image capability, a vocoder capability, a user interface capability, a reply capability, and a memory capability.
